(19) United States
(12) Patent Application Publication
(10) Pub. No.: US 2012/0047485 A1
(43) Pub. Date: Feb. 23, 2012

(54) METHOD FOR ASSISTING IN THE DEVELOPMENT OR USE OF A COMPLEX SYSTEM

(75) Inventors: Michel Lanque, Nozay (FR); Philippe Larvet, Forges Les Bains (FR)

(73) Assignee: Alcatel Lucent, Paris (FR)

(21) Appl. No.: 13/260,617

(22) PCT Filed: Apr. 1, 2010
(86) PCT No.: PCT/FR2010/050623

§ 371 Date: Nov. 7, 2011

(30) Foreign Application Priority Data
Apr. 15, 2009 (FR) 0952477

(51) Int. Cl. G06F 9/44

(52) U.S. Cl. 717/105

(57) ABSTRACT

The present invention relates to a method for assisting in the development or use of a complex system including a plurality of components whose states and/or operations are interdependent, with documentation of the system identifying such states and/or operations, characterized in that it includes the following steps:
The step of identifying the system's use cases (24) in the documentation (10) by automatically searching for symbols related to a use of the system,
The step of generating procedures based on such symbols, such that a procedure will describe an operation carried out by the system in one or more steps by means of its components, and
the step of assisting the user by using object-oriented programming of its procedures based on a UML standard, for “Uniform Modelling Language”.

The present invention relates to a method for assisting in the development or use of a complex system.

The development of a complex system, meaning a system that comprises a multiplicity of components whose states and/or operations are interdependent, generally requires characterizing its functional data and semantically organizing them, as well as creating a graphical representation of its functional architecture.

For example, such a graphical representation makes it possible to assist a user of the system by giving him or her an overview of the system's various components that are required for its operation, in order to verify, approve, and/or optimize of the interaction of these components, to give a few examples.

Such a graphical representation is currently produced manually by technically qualified people who use documents generated during the design, development, and/or production of the system.

To achieve this, these technically qualified people must research, analyze, and/or functionally organize a substantial mass of documents, which are not always relevant and are at times redundant, in order to identify the components implemented by the system as well as their functions and interactions in the various possible uses.

Finally, these technically qualified people must manually reconstitute the components needed for the end-user based on a functional structure by creating a graphical representation illustrating their understanding of the system and its components, particularly their functions and interactions.

It seems that creating a graphical depiction of the functional architecture of a complex system as described above has many disadvantages. Thus, it requires a time- and cost-heavy investment, particularly given the requisite qualification of the people who are employed and the difficulty in understanding the functions of the components or sub-components implemented by a complex system.

Typically, these people are engineers who had taken part in developing the system and/or qualified subcontractors, as permanent actors, and are familiar with the technical language of the system's manufacturer.

However, despite the qualifications of these people, the representation method, by its manual nature, introduces an error risk proportionate to the scale of that human intervention.

Finally, such a method leads to graphical representations that may quickly and easily become outdated due to the context of changes and/or changes during the development of the systems, or in response to a later technical change to the system, which necessitates a new examination of the new technical documents, and a new representation of the system's operation.

Furthermore, according to an aspect of the invention that may be considered independently, it is known that commercializing a complex system requires offering a helpdesk-type assistance service.

Currently, such service is generally constituted by a telephone service and/or an assistance manual.

However, the solutions turn out to be costly and are ineffective, particularly because a user of a complex system who is faced with a failure or a system states message, for example, must search for a response to the failure or an explanation for that message in a general work, which covers the system's entire operation, and is generally complex and long.

The present invention aims to resolve at least one of these problems. It includes the observation that document files generated during the design, development, and production of a complex system are generally written with a document-content structure and/or organization, as well as a similar lexicon and style, that are specific to the technical field and/or enterprise in question.

This is why the present invention concerns a method for assisting in the development or use of a complex system comprising a plurality of components whose states and/or operations are interdependent, documentation of the system identifying such states and/or operations, characterized in that it comprises the following steps:
The step of identifying the system's use cases in the documentation (10) by automatically searching for symbols related to a use of the system,
The step of generating procedures based on such symbols, such that a procedure will describe an operation carried out by the system in one or more steps by means of its components, and
the step of assisting the user by using object-oriented programming of its procedures based on a UML (Uniform Modelling Language) standard.

Owing to the invention, first of all, it is possible to easily and reliably generate a graphical representation of the static functional architecture of a complex system because a representation, or object model, in accordance with a UML standard may be automatically generated by considering each procedure to be a class of that standard.

Thus, the invention makes it possible to generate a graphical representation of the static functional architecture in a simple and reliable fashion, without requiring a heavy cost and long delays.

Such a depiction makes it possible to functionally check and approve the consistency of the functions and interactions of those components of the relevant system.

Furthermore, the generated result corresponds to an automatic processing of one or more document(s). As a result, the risk of error due to a manual reading or representation operation is nonexistent.

Second of all, according to the aspect of the invention that may be implemented independently, the invention also makes it possible to provide helpdesk-type assistance to a user of a complex system by generating real-time indications of the system, which are based on the states and operation of the system, and therefore adapted to its current use.

This is because using the dynamic portion of an object model, in accordance with the UML standard, makes it possible to easily and dynamically generate objects as a function of the system's states.

As a result, when considering a document, such as technical specifications or a user's manual, the method makes it possible to provide a user with relevant information specific to the system's current use, extracted from that document.

In one embodiment, a static portion of the object-oriented programming is used to generate a graphical representation of the system's static functional architecture in which one class of an object model corresponds to a generated procedure.

In one embodiment, a dynamic portion of the object-oriented programming is used to generate messages indicating operations that can be performed by a developer or user as a function of the system's states.

In one embodiment, a procedure is generated by grouping together parameters related to the same use case.

In one embodiment, it is determined that two parameters are related to a single use case by considering a semantic analysis of the symbol and/or an analysis of the symbol's position in the documentation.

In one embodiment, the document being written in words, the symbols correspond to keywords associated with a parameter of a use case.

In one embodiment, each use case is associated with passages of the documentation that comprise the identified keywords.

In one embodiment, an interactive form is used that comprises input fields corresponding to use case parameters and/or procedure parameters for writing the documentation.

The invention also relates to a device for assisting in the development or use of a complex system that comprises a plurality of components whose states and/or operations are interdependent, these states and/or operations being identified by the system's documentation, characterized in that it comprises:
Means for identifying the system's use cases in the documentation by automatically searching for symbols related to a use of the system,
Means for generating procedures based on these symbols, such that a procedure describes an operation performed by the system in one or more steps by means of these components, and
Means for assisting the user by using object-oriented programming of its procedures based on a UML (Uniform Modelling Language) standard, by a method as claimed in one of the preceding embodiments.

The invention also pertains to an application of an assistance method according to one of the preceding claims for using a printer.

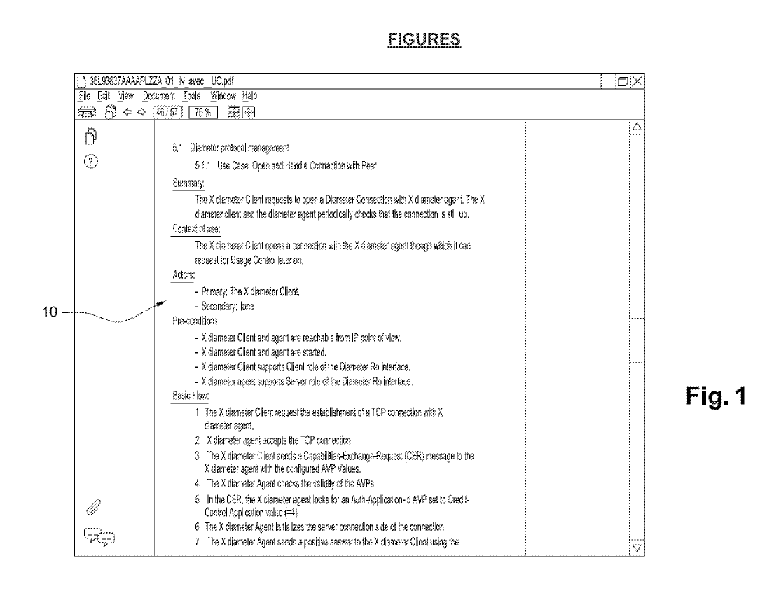

The invention will be better understood in view of the description given below by way of a nonlimiting example, with reference to the attached figures in which FIGS. 1 to 6 are screenshots illustrating the proceeding of a method according to the invention.

FIG. 1 detects a documentation, in the form of a text 10, intended for developer and/or a user of a complex system. In this example, this document is a technical specification of a complex system related to establishing a connection.

Such a system therefore comprises a plurality of components, particularly the client terminal and the agent, whose states and/or operations are interdependent, because, for example, the client terminal requires the establishment of a TCP connection with the agent—point 1. of the section entitled “basic flow”.

In accordance with the invention, it is possible to automatically generate an object model of this system, in accordance with a UML (Unified Modeling Language) standard, by first identifying the system's use cases described in that text 10.

To that end, a keyword search is carried out within the text 10 by means of automatic character recognition. For example, the search is carried out on terms generally used to specify a parameter of a use case.

A nonlimiting list of such terms includes:
“context” to describe the context of a function within the system, e.g. one that is subsequent to another function,
“summary” for presenting that function in a summarized fashion,
“actors” for identifying the components that implement the function,
“starter event”, for indicating an event that begins the function,
“pre-conditions” for the states or conditions that the system is experiencing before an operation,
“input parameters” and “occuring events” for source data that is considered before a function begins,
“operations” for the basic operations implemented by the system,
“output data” the data provided by the system,
“post conditions” for the states or conditions that the system and/or its components are experiencing after having executed an operation,
“result” for presenting the result of an operation,
“links with other functions” for giving the list of operations,
“graphical interface” for graphically representing a function,
“exceptions” and “alarms” for reporting abnormal system states.

However, the search for these keywords may be expanded by using a database indicating terms that may specify a parameter of a use case with synonyms, acronyms, and all types of terms specific to, for example, an enterprise, a technical field, and/or a type of product.

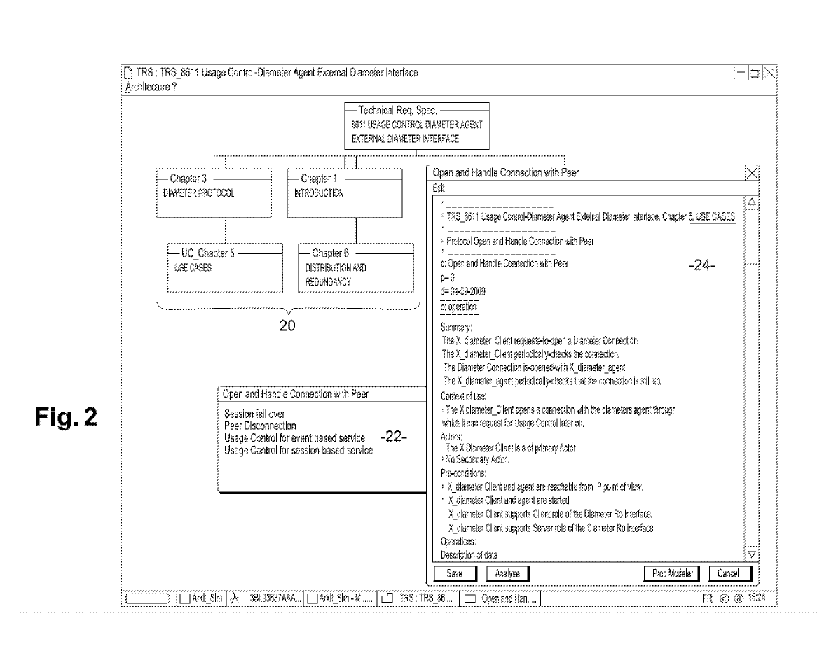

Owing to the structure of the document, it is also possible to represent these main parts, or chapters 20 (FIG. 2), of the identified general indications 22 or use cases 24.

In this embodiment, when a keyword has been identified, a portion of the text 10 comprising that keyword is extracted and is considered to be a parameter of a use case. Typically, this portion may correspond to a section that includes that keyword.

Afterward, according to a second step specific to the invention, procedures are generated in the language of the text, with a procedure describing an operation carried out within the system so that the user can be assisted by using, during a third step, an object-oriented programming derived from these procedures.

To that end, all the parameters related to a single use case are associated within a procedure by using, for example, a semantic analysis and/or an analysis based on the position of one or more keywords in the text in order to determine whether two parameters relate to a single use case.

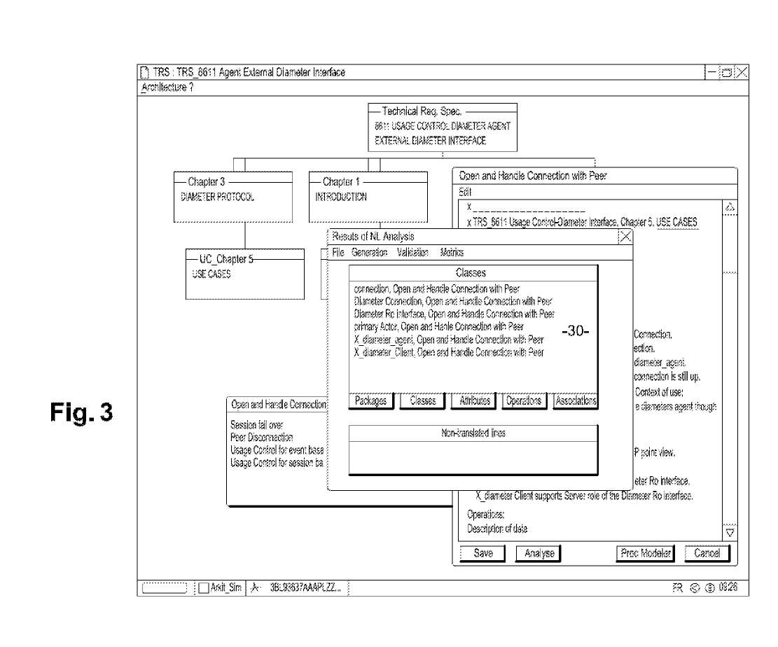

The result of such a semantic analysis is represented in FIG. 3 with a “classes 30” denomination subsequent to a neurolinguistic analysis of the identified keywords.

Afterward, parameters are associated by generating objects that comprise, using a similar order for each object, the associated passages of the tax.

In accordance with the invention, the user is then assisted by using an object-oriented programming based on procedures that comprise those portions of the text according to a UML (Uniform Modelling Language) standard.

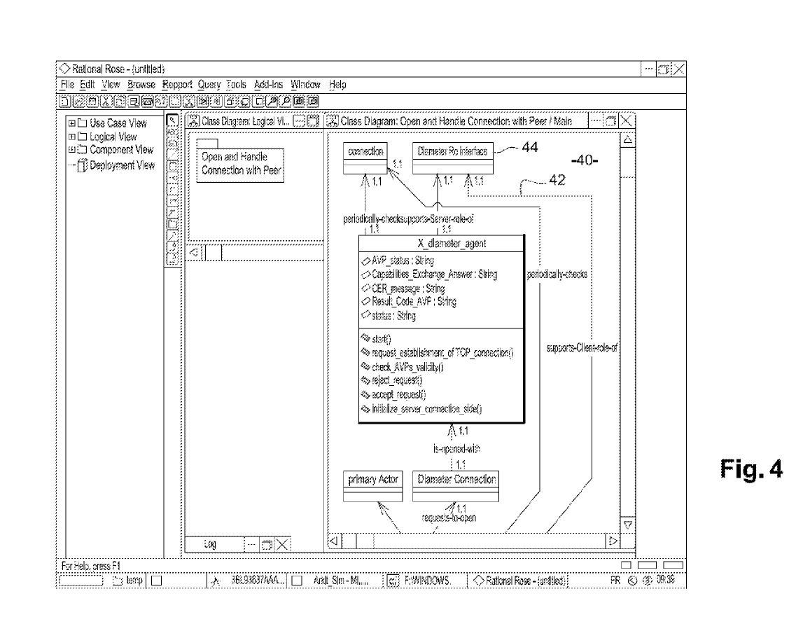

Such a standard thereby makes it possible to generate a graphical representation 40 (FIG. 4) of the system's static functional architecture, by considering each procedure to be a class (44) of an object model.

To that end, some properties of the previously identified procedures are converted into attributes of a UML class.

This way, it becomes automatic to obtain this static functional replication 40 of a system's architecture by using a representation of these classes in accordance with a static functional model specific to the ULM standard.

In particular, such a depiction 40 shows the functional links 42 so that it is easy to verify that the absence of such a link in order to approve the system.

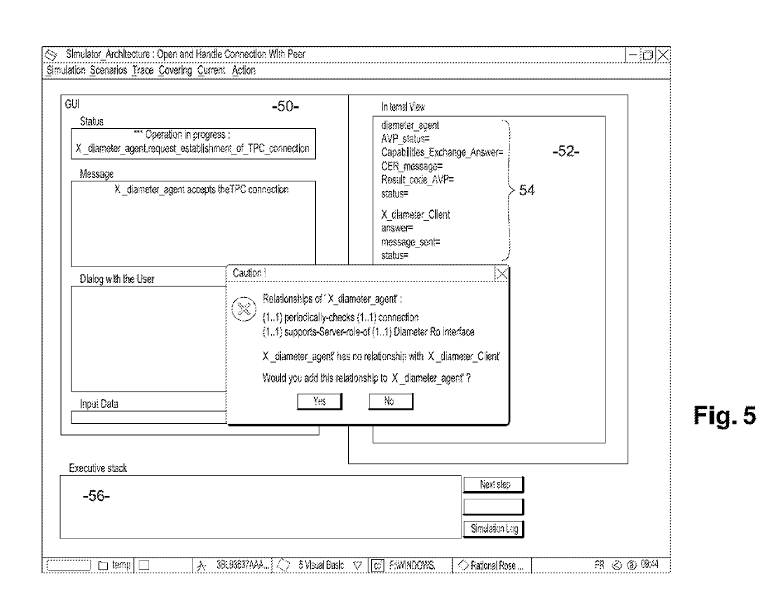

Thus, as depicted in FIG. 5, a user interface 50 may inform the user of the progress of the system's operation, while an internal interface 52 informs a developer/programmer of the internal data 54 required to implement an operation whose execution 56 cannot be performed due to that absence.

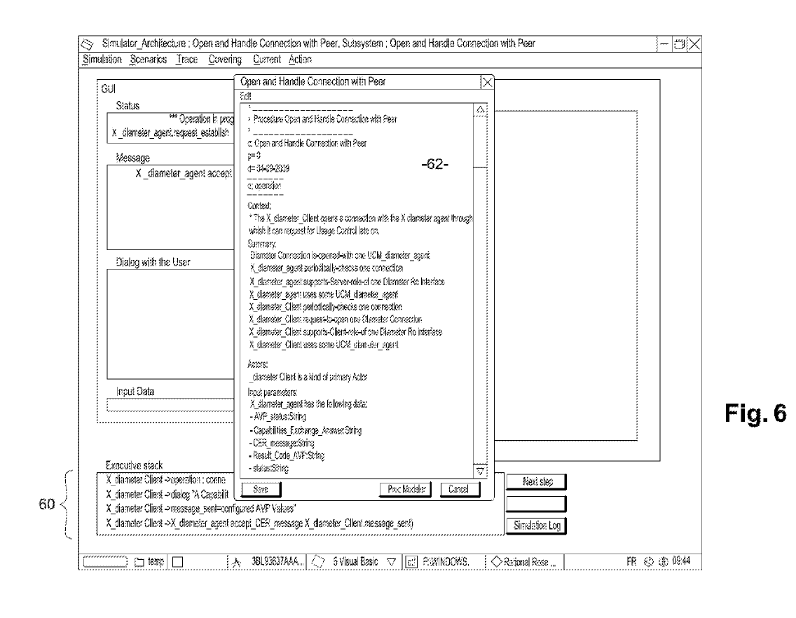

Once the missing link is restored, execution 60 (FIG. 6) is possible and a summary 62 of that operation may be presented.

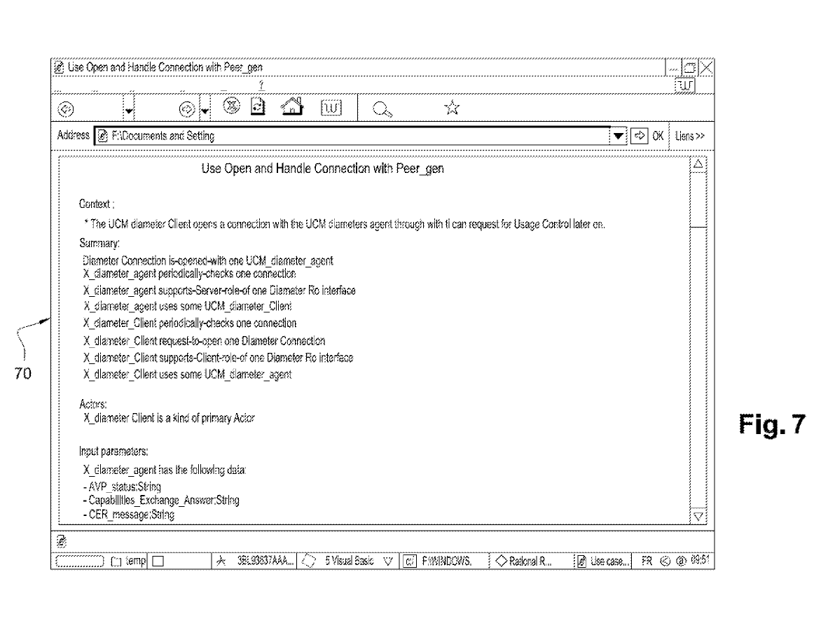

In fact, according to another dynamic application, which may be used independently of the static application, a dynamic portion of the UML's object-oriented programming is used to generate scripts 70 (FIG. 7) indicating operations that may be performed by the user as a function of the system's states.

In order to do so, the basic text in question is a user manual-type text that describes the actions that can/must be performed by an operator as a function of the operations and/or states of the system's components.

In this situation, procedures generated according to the invention comprise portions of that manual, extracted by a method according to the invention, indicating the operations that must be performed by the user as a function of the system's operations and/or states.

In this situation, using the dynamic portion of the ULM standard makes it possible to display the relevant procedure, meaning the relevant portions of the manual, as a function of the system's states and/or an operation of the system.

Thus, the invention makes it possible to generate a proactive helpdesk, i.e. one that takes action before the user makes a request, and provides targeted, evolving information as a function of the system's use.

The present invention may, for example, be used in the field of printers, in which maintenance and/or repair operations may be provided to a user.

The present invention is open to many variants: For example, it is possible to use an interactive form that comprises input fields corresponding to use case parameters and/or procedure parameters in order to write the basic text in such a way that the character recognition operation is limited to recognizing the input fields.

Likewise, the invention's applications may be diverse, and may relate, by way of a nonlimiting example, to a server, a computer, or generally speaking, a device performing operations such as a peripheral, like a printer or mobile telephone.

1. A method for assisting in the development or use of a complex system comprising a plurality of components whose states and/or operations are interdependent, with documentation of the system identifying such states and/or operations, the method comprising:
identifying the system's use cases in the documentation by automatically searching for symbols related to a use of the system;
generating procedures based on such symbols, such that a procedure will describe an operation carried out by the system in one or more steps by means of the components; and
assisting the user by using object-oriented programming of the procedures based on a UML (Uniform Modelling Language) standard.

2. The method according to claim 1, characterized in that a static portion of the object-oriented programming is used to generate a graphical representation of the system's static functional architecture in which one class of an object model corresponds to a generated procedure.

3. The method according to claim 1, characterized in that a dynamic portion of the object-oriented programming is used to generate messages indicating operations that can be performed by at least one of a developer or a user as a function of the system's states.

4. The method according to claim 1, characterized in that a procedure is generated by grouping together parameters related to a same use case.

5. The method according to claim 4, wherein it is determined that two parameters are related to a single use case by considering a semantic analysis of at least one symbol of said symbols and/or an analysis of the at least one symbol's position in the documentation.

6. The method according to claim 1, characterized in that, the document being written in words, at least one symbol of the symbols correspond to keywords associated with a parameter of a use case.

7. The method according to claim 6, wherein each use case is associated with passages of the documentation that comprise the identified keywords.

8. The method according to claim 1, characterized in that an interactive form is used that comprises input fields corresponding to at least one of use case parameters or procedure parameters for writing the documentation.

9. An apparatus for assisting in the development or use of a complex system comprising a plurality of components whose states and/or operations are interdependent, with documentation of the system identifying such states and/or operations, the system comprising:
a means for identifying the system's use cases in the documentation by automatically searching for symbols related to a use of the systerm;
a means for generating procedures based on these symbols, such that a procedure describes an operation performed by the system in one or more steps by means of these components; and
a means for assisting the user by using object-oriented programming of these procedures according to a UML (Uniform Modelling Language) standard.

10. (canceled)

11. The method of claim 1 further comprising a printer that is configured to execute the method of claim 1.
